(19) United States
(12) Patent Application Publication
(10) Pub. No.: US 2026/0019430 A1
(43) Pub. Date: Jan. 15, 2026

(54) CLASSIFICATION OF NETWORK FLOW DATA TO IDENTIFY CYBER THREATS

(71) Applicant: AT&T Intellectual Property II, L.P., Atlanta, GA (US)

(72) Inventors: James Brunner, Holmdel, NJ (US); Laurie Kraus, Old Bridge, NJ (US); Kevin Ackerman, Toms River, NJ (US); James Cignarella, Millstone Township, NJ (US)

(73) Assignee: AT&T Intellectual Property II, L.P., Atlanta, GA (US)

(21) Appl. No.: 18/772,959

(22) Filed: Jul. 15, 2024

(51) Int. Cl. H04L 9/40

(52) U.S. Cl. CPC H04L 63/1416; H04L 63/1425

(57) ABSTRACT

Aspects of the subject disclosure may include, for example, receiving information about known malicious activity, the information about known malicious activity corresponding to a known cyber threat to operation of a network or data processing system, using a clustering process to label flow data for identifying the information about known malicious activity, receiving production flow data corresponding to current network traffic arriving at the network or the data processing system, determining clusters and cluster identifiers for the production flow data, identifying a relationship between a cluster label for the information about known malicious activity and a cluster identifier for the production flow data, and based on the relationship between the cluster label for the information about known malicious activity and the cluster identifier, identifying a potential cyber threat to the network or the data processing system. Other embodiments are disclosed.

### STATEMENT REGARDING FEDERALLY SPONSORED RESEARCH OR DEVELOPMENT

This invention was made with government support under 23-C-0187 awarded by the United States Intelligence Community. The United States government has certain rights in the invention.

### FIELD OF THE DISCLOSURE

The subject disclosure relates to a system and method for classification of network flow data for identification of cyber threats in a network.

### BACKGROUND

Network operators have a never-ending job of protecting networks from external threats. Such threats may include introduction of malware to the network, theft of data and other information from the network, and other risks to proprietary information as well as reliable operation of the network. Every network connection to an outside network or data path creates a risk that must be monitored and defended.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within the communication network of FIG. 1 in accordance with various aspects described herein.

FIG. 2B depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for a system and method for classifying network flow data by performing analysis such that network traffic with similar characteristics can be grouped together by assigning a label to flow records. By comparing sets of labeled flow data with samples of known malicious network flow traffic, for example email tied to known threat actors perpetuating ransomware, the system can identify what caused the malicious flow data that this traffic represents. The system and method detect current cyber-attacks and predict future cyber-attacks by identifying network traffic with similar characteristics to known malware and the like. Other embodiments are described in the subject disclosure.

One or more aspects of the subject disclosure include receiving information about known malicious activity, the information about known malicious activity corresponding to a known cyber threat to operation of a network or data processing system, using a clustering process to label flow data for identifying the information about known malicious activity, receiving production flow data corresponding to current network traffic arriving at the network or the data processing system, determining clusters and cluster identifiers for the production flow data, identifying a relationship between a cluster label for the information about known malicious activity and a cluster identifier for the production flow data, and based on the relationship between the cluster label for the information about known malicious activity and the cluster identifier, identifying a potential cyber threat to the network or the data processing system.

One or more aspects of the subject disclosure include receiving production flow data corresponding to current network traffic arriving at an enterprise network, providing the production flow data to a classifier, receiving, from the classifier, inferred labels for flows of the production flow data, and based on a relationship between the inferred labels for the flows of the production flow data and labels for flows from known malicious activity, identifying in the production flow data a potential cyber threat to the enterprise network.

One or more aspects of the subject disclosure include receiving ground truth information about known malicious activity in data networks, identifying cluster labels for the ground truth information, receiving production flow data corresponding to current network traffic arriving at an enterprise network, the production flow data comprising flows of the production flow data, determining cluster identifiers for flows of the production flow data, and based on relationships between the cluster labels for the ground truth information and the cluster identifiers for the flows of the production flow data, identifying a potential cyber threat to the enterprise network.

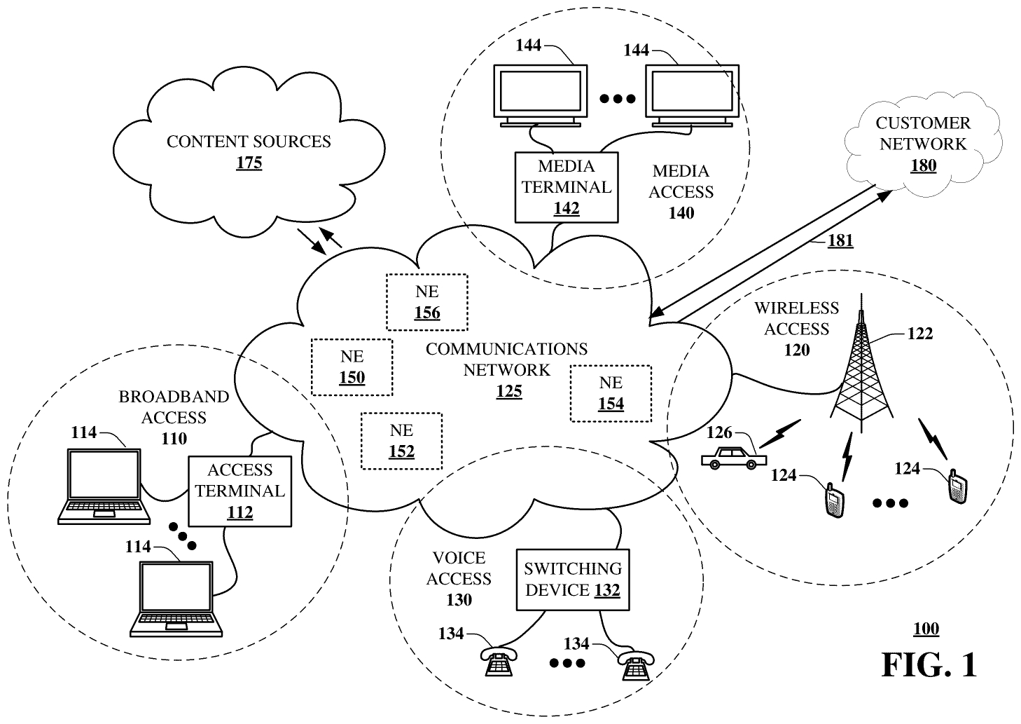

Referring now to FIG. 1, a block diagram is shown illustrating an example, non-limiting embodiment of a system 100 in accordance with various aspects described herein. For example, system 100 can facilitate in whole or in part classifying network flow data in the system 100 by assigning a label to similar flow records and comparing the labeled flow records with known malicious network flow traffic to identify a source of the malicious traffic in the current network traffic. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communications network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VOIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VOIP gateway or other gateway device and/or other switching device. The telephony devices 134 can include traditional telephones (with or without a terminal adapter), VOIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

In various embodiments, the communications network 125 can be in data communication with a customer network such as customer network 180. The customer network 180 may implement any sort of network service including applications, data storage, communications, and other activities. In general, the customer network 180 includes a firewall or other security mechanism designed to block unauthorized access while permitting outward communication from the customer network 180. In the example of FIG. 1, the customer network 180 is in data communication with the communications network 125. Access to the customer network 180 may be through one or more portions of the system 100 including the communications network 125.

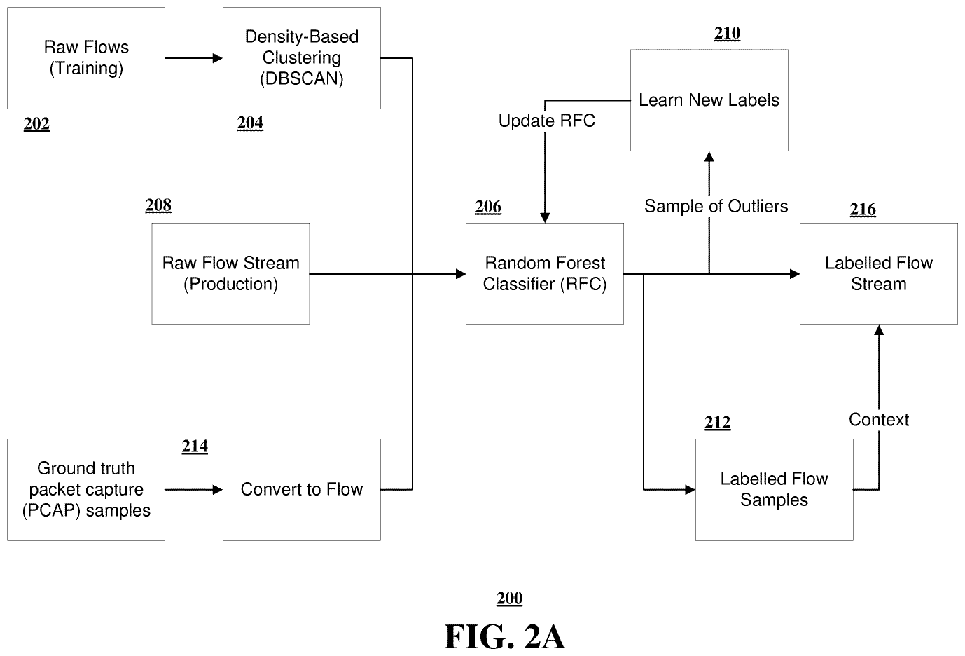

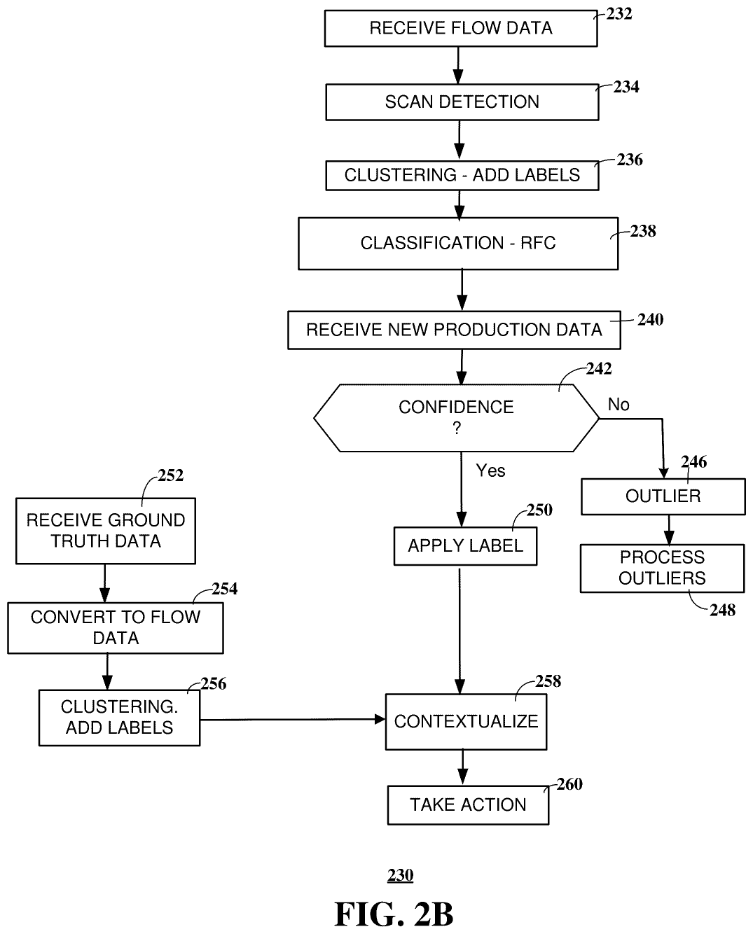

FIG. 2A is a block diagram illustrating an example, non-limiting embodiment of a system 200 functioning within the system 100 of FIG. 1 in accordance with various aspects described herein. In embodiments, the system 200 may be positioned physically and functionally at peering points between the customer network 180 and the communications network 125. The system 200 may operate to filter or limit access to internet traffic on the customer network 180 that crosses the communications network 125. The system 200 may operate to filter traffic on a specific set of internet protocol (IP) addresses in some embodiments, such as based on a list of suspicious IP addresses. In other embodiments, the system 200 may operate to filter traffic based on the public facing IP space of the customer network 180. The system 200 may operate on other types of network traffic as well.

The system 200 may be used to identify, predict and prevent cybersecurity attacks before they occur and can cause damage. In particular, the system 200 forms a system for classifying network flow data by performing analysis such that network traffic with similar characteristics can be grouped together by assigning a label to flow records. In the exemplary embodiment of FIG. 2A the system 200 includes a raw flow data training process 202, a clustering process 204, a traffic classifier process 206, a raw flow stream production process 208, a learn new labels for outliers process 210, a ground truth flow sample labelling process 212, a ground truth packet capture and conversion to flow data process 214, and a contextualize production flows with meaningful labels process 216. Other embodiments may include other processes or may be organized differently yet still achieve similar outcomes.

Network flow data (hereafter referred to as flow) comprises internet protocol (IP) packet header metadata which is collected at the network edge to concisely record every network transaction passing the perimeter. Generally, IP networking flow is a unique combination of source IP address and destination IP address, source port and destination port, and protocol for an IP packet. The flow may be defined as a set of IP packets passing an observation point, such as a network boundary, during a given time interval. Collection of flow data provides full coverage of all the network-based communication activities which were conducted during a timeframe. Flow records are uniformly sized and structured, making straightforward processes of parsing and manipulating the data files efficiently. Flow records capture an especially useful set of Transmission Control Protocol/Internet Protocol (TCP/IP)-based information including the IP address and port for the source and destination of the communication, protocol, TCP flags, volumetric data on the number and size of the packets and bytes, as well as the accompanying timestamp.

One important value of IP flow metadata to the cyber-threat analyst is in the coverage and conciseness of IP flow metadata. Such IP flow metadata is an efficient way to monitor the enterprise network edge and see all the traffic coming in and out of the network. In examples, this may include data passing in and out of the broadband access 110 as shown in FIG. 1, wireless access 120, voice access 130, and media access 140, as well as communications network 125, or any combination of these. IP flow metadata is also concise and privacy-conscious since it contains no user content, but only endpoint identifiers (IP addresses), times, and volume measurements.

Humans have necessarily been involved in identifying and defending against network attacks. However, trained and experienced cybersecurity specialists are often scarce, especially in relation to the scope of the task. Human network defenders spend much of their attention on threat detection, incident response, containment, and mitigation. Cybersecurity is an industry with increasing importance, but there is a notable lack of highly skilled professionals who can identify and mitigate threats. The problem with use of flow data by cyber-threat analysts is that gleaning evidence of specific details of cyber threats and cyber-attacks, including threat actors, malware used, etc., requires a considerable amount of training and experience for threat analysis. Also, while there are existing tools for inspecting and summarizing flow data used for threat analysis, threat hunting using flow data is still labor intensive.

There have been attempts to link flows to cyber threats. Many analytic solutions using flow data involve creating Machine Learning (ML) models and algorithms which target one specific type of malware. These efforts may take months to implement. After such a delay, most malware has evolved and generates flow data with different characteristics, which may leave cyber-threat analysts with an analytic that produces a sea of false positives. Such conventional responses have largely been too little, too late.

Most current, conventional, cybersecurity algorithms are reactive rather than predictive. Such conventional algorithms identify an attack after the attack happened. An example is Distributed Denial of Service (DDOS) attacks, which may use multiple devices to overwhelm a target with requests, making it unable to respond to legitimate requests and forcing the target offline.

Conventionally, the most prevalent use of predictive analytic algorithms in cybersecurity are based on time-series, volumetric data. By establishing a baseline of normal traffic volumes and associated variations from the normal, these algorithms can produce a range of traffic volumes that would be considered normal in the future. The algorithms are still essentially reactive since they are predicting trends, but not specific cyber-attacks.

A system and a method in accordance with various aspects described herein relate to classifying network flow data by performing analysis such that network traffic with similar characteristics can be grouped together by assigning a label to flow records. By comparing sets of labeled flow data with samples of known malicious network flow traffic, for example email tied to known threat actors perpetuating ransomware, the system can identify what caused the malicious flow data that this traffic represents. Current cyber-attacks can be detected, and future cyber-attacks predicted by identifying network traffic with similar characteristics to known malware and the like.

Network traffic generated with the same or similar software tools and applications, users, ports and protocols, and other methods, can be identified and classified. Classification of network traffic may include assigning a label to a flow or other unit of network traffic. Labelled flow records with features similar to known malware can subsequently be used to increase the severity of potential cyber incidents under investigation. Such cyber incidents generally require the quickest response from human cyber-threat analysts. Threat hunting with flow data requires a lot of experience and understanding of networks, protocols, etc. The ability to contextualize flow data with language that experienced cyber-threat analysts understand, such as malware families, MITRE ATT&CK® TTPs (tactics, techniques, and procedures), etc.), enables the cyber-threat analysts to assess threats and prioritize responses more quickly and with greater accuracy. MITRE ATT&CK® is a knowledge base of adversary tactics and techniques based on real-world observations and is available to users over networks such as the public internet. MITRE ATT&CK® is a registered trademark of The MITRE Corporation.

Embodiments of the system and method create a flexible and extensible system that links flow data to malicious software that is known to generate network traffic with the same characteristics. The system classifies the type of network traffic and labels every flow record such that similar or repeated flows get the same label. Samples of malicious traffic (referred to as ground truth) are processed to automatically classify the type of traffic such that it is given a label with a meaningful name, such as the threat actor name, malware or ransomware family, and the like. Embodiments use these named flow labels together with the production flow data to detect current cyber-attacks and predict future attacks by identifying traffic in the network under analysis with similar characteristics to known malware.

While network flow data is very useful from a cyber security perspective, the meaning or import of such flow data may be difficult to discern, especially for network analysts who lack special training or deep levels of experience. In accordance with embodiments described herein, awareness may be brought to such analysts of the severity of different types of flow data based on similarity of the flow data to samples that have known malicious traffic associated with them.

The flow data is an aggregation of network traffic including information about communication endpoints plus some volumetric statistics that have been transmitted and received between the endpoints. The flow data is useful for volumetric analysis plus threat hunting and determining where a threat may lie. Flow data is unidirectional and includes information about a sum of a number of packets and the number of bytes transmitted between a start time and an end time. For a very long duration connection between the endpoints, a particular flow record could be quite long. However, for use by analysts in near-real-time applications (such as those that produce a result or determination on a time scale of seconds or minutes), the flow data may be segmented into many different records that have incrementing and time stamps. Flows may correspond to a request and a response, such as between a client and server.

Conventionally, flow data has been used for identifying the endpoints and attempting to associate them with known threats. This may include determining how IP addresses may be used by adversaries to conduct attacks. Related information such as history and prior behavior may be used along with geolocation information for one or both of the endpoints. Some locations may be considered more of a threat than others. Further, some attention has been given to looking at volumetric statistics. Thus, a small number of packets or bytes may be dismissed as less likely to be threatening. Correspondingly, a large number of packets or bytes, such as megabytes or gigabytes, especially if they are outbound from a network, might be associated with exfiltration of data from the network.

In contrast with conventional efforts, a method and system in accordance with various aspects described herein seeks to assign a suspicion or a threat level to as many flows as possible. For example, a typical network might receive billions of records per day. Analyzing this data may enable prediction and prevention of unauthorized access to the network.

Referring again to FIG. 2A, it illustrates a system 200 for flow traffic classification by labelling flows. The flows may be received at or transmitted from a network such as an enterprise network. The enterprise network or other network provides data communication and processing for users within the network and for users accessing the network. An example is a network that provides user access to one or more application programs at a server. The server receives requests from client devices over a network and provides responses to the client devices.

The network may have limited ingress from and egress to other networks in order to control risk of access by persons having malicious intent. For example, a firewall may be established around the network to limit and control access. IP flows may be analyzed and used to give context for human analysts. The IP flows may be used to identify risks, follow-up on such risks and defend against unwelcome access.

The system 200 may include any suitable combination of devices for identifying and minimizing risks. For example, a processing system including a processor and memory storing instructions, may be dedicated to analysis of IP flows in the network, and all incoming and outgoing flows are routed to the processing system. In another example, the processes performed by the system 200 may be shared among a number of interconnected data processing systems.

The scan detection process 202 includes a process of scan detection and separation. The flow data is initially processed to perform scan detection, which is to filter out and set aside flow records with the characteristic of scanning the internet. An actor who is scanning sends a large number of connection attempts to a large number of destinations. This may be done with or without malicious intent. The actor is primarily testing to see what access can be had. Scanning can generate a substantial number of flow records. This scanning can be benign, such as research to understand internet characteristics, or it can be malicious, such as looking for servers (IP addresses) tied to known vulnerabilities. Scanning comprises a large percentage of internet traffic and the highest volume of flows. Therefore, initially, scanning activity is identified and set aside. Based on experience, there is generally very little value in scanning data as individual records. At the scan detection process 202, other internet port and protocol heuristic-based partitioning is also performed, including feature extraction based upon well-known port and protocol combinations.

At clustering process 204, a process to cluster similar flow records is performed on received flow data. Any suitable algorithm may be used for clustering the data. One example algorithm is Density-Based Spatial Clustering of Applications with Noise (DBSCAN). DBSCAN operates on a set of points in a space by grouping together the points that are closely packed. DBSCAN or other clustering algorithms operates to take completely unlabeled data such as the raw training flows in FIG. 2A and learn the relationship between features of the input data. The result is a label for the output data in which similar or related data are clustered under that label.

The clustering process 204 is used to determine hyperparameters used by machine learning processes and to tune such hyperparameters. For a machine learning system, hyperparameters specify details of the learning process such as a learning rate or a choice of an optimizer. For the system 200, one exemplary hyperparameter corresponds to be the acceptable distance between two data points to have them considered to be within the same cluster and therefore to be related to one another. Another exemplary hyperparameter for the system 200 is the maximum number of data points contained in a single cluster without breaking the cluster apart. By adjusting the hyperparameters, a large number of different clusters may be developed. Human analysis may be used to verify the results of the clustering process and to modify hyperparameters to obtain satisfactory results.

During the clustering process 204, received flow records are separated into different buckets or categories based on predetermined heuristics. For example, a flow record may be categorized based on what input port is involved in receipt of the flow record. In another example, a flow record may be categorized based on duration. In general, most of the buckets or categories have their own machine learning pipeline associated with them that starts with that clustering.

The clustering process 204 operates to determine what flows or group of flows really are very similar to one another. In some cases, the clustering process 204 may identify several different types of flows that get put into the same cluster. However, that is not desirable. Rather, members of each cluster should have characteristics which are similar and distinct from other clusters.

At the machine learning model 206, a Random Forest Classifier (RFC) is trained using the clusters from the clustering process 204 as labels. Random Forest is a popular supervised machine learning algorithm, which in this case is used for classification. Because the initial label data is generated by clustering and not by humans or an external process, getting 100% training accuracy means that the system's clustering hyperparameters successfully divided up the flows into separable multi-dimensional space.

In embodiments, any suitable machine learning model or artificial intelligence process may be used for classification by the machine learning model 206. However, the Random Forest algorithm in some applications is a better algorithm for inference when taking new data that is unlabeled and applying a cluster identifier to the new data.

At the production process 208 new data is received as part of a production implementation of the system 200 in a network such as an enterprise network. The received data are streams of raw flow data. The RFC classifier is trained at the machine learning model 206 to identify differences between different cluster identifiers. Following receipt of the raw flow data at production process 208, the RFC of the machine learning model 206 is then applied to the new flow data received in flows during production.

As new flows come in, the RFC of the machine learning model 206 has two main responsibilities. A first responsibility is to apply a label on every flow record and pass it forward for later processing. The flow sampling process 212 provides a labelled flow stream to the contextualize production flows process 216. Second, the RFC may assign a confidence parameter or data indicating how likely it was that the label applied is the correct label to the flow. In some cases, the confidence level may be relatively low. In the example, they are termed outliers. Any suitable threshold value of relation may be used to define outliers, such as a confidence level less than 0.5 on a scale of 0.0 to 1.0. Defining outliers in this manner allows the system 200 to stay flexible to new types of attacks and new types of traffic, for example, that the system 200 might see over time and without having to repeat the clustering process 202. In embodiments, the confidence level and threshold values may be adjustable by a human security analyst, for example, by accessing a user interface or dashboard at a computer system.

In the model update process 210 the RFC infers labels for all newly received flow data at the network. Such newly received flow data includes outlier flows which have not been seen before or have not been seen in a significant volume before. For example, a count may be maintained of received clusters having a particular cluster identifier. If the count for a particular cluster identifier does not exceed a count threshold, indicating the cluster identifier has not been received often in the past or is an infrequently seen cluster identifier, the cluster and the cluster identifier may be tagged as an outlier. New clusters may be identified based on a coincidence in time of similar outliers among received clusters based on a number of outliers exceeding a count threshold within a predetermined time threshold. Any suitable value of the count threshold, such as 100 outliers, and the time threshold, such as one day or one week, may be used.

The model update process 210 handles flows that are determined to be outliers. In an example, all flows determined to be outliers are collected in a pool or group. A process termed outlier matching is applied to the outliers. The probabilities of each flow record belonging to a previously known and labeled cluster are used to find new clusters within the group of outliers. Any suitable process may be applied. In an example, the model update process 210 looks at flows that have similar probability distributions of belonging to existing labels but are considered an outlier. The flows likely have the same features. This process is similar to what, for example, DBSCAN clustering does. In an example, a number of flows on the order of 10 to 100 per week are identified as outliers in which new clusters are identified. The new labels for newly identified clusters in the outliers are provided by the model update process 210 to the machine learning model 206 to update the RFC. Thus, as attempts to breach the security of the network protected by the system evolve over time, the RFC evolves as well by learning new labels for new clusters identified in the raw flow streams.

At the ground truth labelling process 214, the system 200 pulls in ground truth network data from public sources. Examples of such public open sources include sandboxes, self-generated samples, and other sources. In general, participants in public sandboxes and other public sources will submit to the public source information such as executable files received from a suspicious source and uniform resource locators (URLs) or network addresses received in a suspicious email, for example. The suspicious executable or URL can be processed in a sandbox or other isolated testing environment that enables the participants to run the executable or access the URL without affecting an application on which it is run. One publicly available source is available at JoeSandbox.com, for example. This source detects and analyzes potential malicious files and URLs on Windows, Mac OS, and Linux for suspicious activities. This source performs deep malware analysis and generates comprehensive and detailed analysis reports. The data received from such public sources is in the form of packets of data captured from internet or enterprise traffic (referred to as packet capture or PCAP). These packets are of known traffic types, such as specific types of malware or ransomware, internet scanning, or they may be benign. These packets may further include content as well.

The sandbox will execute the file, visit the URL, or undertake the suspected activity. The sandbox will further track everything that happens as a result of processing the executable file or visiting the URL. One aspect tracked by the sandbox is network activity. Tracked information may be available in an application programming interface (API) for public submissions or in a private submission model with results provided to only a requestor for the sandbox services. The tracked information may be received as a sample submitted to an open source sandbox along with information about network activity generated by the sample. The tracked information may be received as PCAP data.

In the example, the ground truth labelling process 214 converts the PCAP data to flow metadata and then runs the same inference RFC process in the machine learning model 206 to determine the label or cluster identifier of the ground truth flow data. This creates an association between malicious traffic and a cluster identifier or label.

Further, the ground truth labelling process 214 can convert the label to a more meaningful label. The RFC of the machine learning model 206 produces clusters having a numeric label. However, numeric labels are of limited value for the human cyber-threat analysts. Rather than a numeric label, the human analysts may work more intelligently and more efficiently with a meaningful, descriptive, textual label. An example of a more human-meaningful label is “DDOS attack.” When a human analyst sees that label, or other similar labels, the label evokes certain responses in the analyst, may trigger a particular set of steps to resolve the cluster with that label, and may serve as a mnemonic device to assist the analyst.

The contextualize production flows process 216 in some embodiments uses the flow labels to populate a knowledge base to contextualize predictions. Contextualizing may include drawing a connection for identifying what kind of malware generates similar flows, or types of flows. In some embodiments, a linkage to MITRE ATT&CK® TTPs is provided when possible to convey knowledge in a language meaningful to the cyber-threat analyst. The linkage may be over a network and may include a suitable user interface or dashboard accessible on a user device such as a laptop computer by the analyst. This ultimately helps to integrate examination of flow data and predictions of cyber-attacks based upon that data into the cyber-threat analyst's normal workflow.

In some embodiments, the contextualize production flows process 216 may provide a textual message or narrative that is readily understood by the cyber threat analyst. For example, the contextualize production flows process 216 may provide examples of different types of malware that have generated similar flows. An example message is, “other flows with these same characteristics are known to be associated with Cobalt Strike C2,” where Cobalt Strike C2 is a cyber security simulation tool. Such information about known malware and known effects originates in the ground truth PCAP samples of the ground truth labelling process 214. Such messages to the analyst may be supplemented on the user interface by graphical images, sound and other presentations formats in order to give the analysts additional detail to inform and direct follow-up actions to respond to detected activity.

Moreover, in some embodiments, the analyst may be provided with a search tool for searching databases or other storage systems for similar known examples. A search query may have the form of, “Show me flow records associated with Cobalt Strike malware.” The system 200 may provide such examples to the user or analyst. Further, the analyst may search to find groups or organizations that might be impacted by that type of malware.

The information determined by the system 200 and provided to the analyst is generally meant for passive defense. The analyst may use the information in any suitable manner. For example, the analyst may initiate an active defense for the network such as blocking a particular IP address or port on a firewall protecting the network. Further, if the system 200 indicates a type of malware consistent with characteristics of a particular flow, the analyst may investigate to determine if such malware activity is occurring in the network.

FIG. 2B depicts an illustrative embodiment of a method 230 in accordance with various aspects described herein. The method 230 may be performed to classify network flow data in a network in order to identify cyber threats. The National Institute of Science and Technology of the U.S. Government defines a cyber threat as “Any circumstance or event with the potential to adversely impact organizational operations (including mission, functions, image, or reputation), organizational assets, or individuals through an information system via unauthorized access, destruction, disclosure, modification of information, and/or denial of service. Also, the potential for a threat-source to successfully exploit a particular information system vulnerability.” Further, a cyber threat may be defined as “A possible danger to a computer system, which may result in the interception, alteration, obstruction, or destruction of computational resources, or other disruption to the system.” Other definitions may incorporate other activities, harms and effects.

The method 230 may be performed at any suitable location such as a data processing system in a network of a network operator that provides network access to a customer, or in a data processing system of the customer. The method 230 may be initiated by any processes such as receipt of data at a network peering point of the network operator network and the customer network.

At step 232, the method 230 includes receiving flow data. Generally, IP networking flow or flow data includes a unique combination of source IP address and destination IP address, source port and destination port, and protocol for an IP packet. The flow may be defined as a set of IP packets passing an observation point, such as a network boundary, during a given time interval.

At step 234, a scan detection process may be performed. Some flow records that may be received at step 232 may be produced by scanning the internet, in which an actor sends a large number of connection attempts, for example, to a large number of destinations to assess vulnerabilities or for another reason. Scan data generally is not useful for threat detection so, at step 234, the scan data may be recognized and removed from further processing.

At step 236, the received data is clustered and labels are added. Any suitable algorithm may be used for clustering the data, such as DBSCAN. The clustering algorithm operates to take completely unlabeled input data such as the raw flows received in step 232 and to learn the relationship between features of the input data. The result is a label for the output data in which similar or related data are clustered under that label.

At step 238, a classification process occurs for the clustered data. In embodiments, a machine learning model may be used for classification. In particular embodiments, a Random Forest Classifier (RFC) is trained using the clusters from the clustering process of step 236 as labels. Any suitable process, including any artificial intelligence process, for clustering may be used.

At step 240, new production data is received and processed by the method 230. For example, in an implementation, a network operator provides classification of network flow data at a customer network in order to identify cyber threats. The received production data includes flow data includes an aggregation of network traffic including information about communication endpoints, plus volumetric statistics that have been transmitted and received between the endpoints. The flow data is useful for volumetric analysis plus threat identification and determining where a threat may lie. The new production data may be applied to the classifier, such as a random forest classifier, to obtain labels for categorizing the production data.

At step 242, the method 230 includes a process of determining a confidence level for the inferred labels determined for production data at step 242. In embodiments, flows with high prediction probabilities for a label from the RFC get stamped with that label, step 250. Any probability measure may be used. Conversely, flows without a high probability of being accurately labeled are designated as outliers. At step 246, the outliers get stamped with a special outlier label and put into an outlier pool or group. At step 248, the method 230 processes the flows in the outlier pool periodically to find accumulations of flows with the same prediction probability vector and form new clusters or labels from those flows. The new clusters and labels may subsequently be used to classify future incoming production data. Information about the new clusters or labels may be combined with clusters and labels determined at step 236, for example.

In a separate process, at step 252, the method 230 pulls in ground truth data. Such ground truth data may be retrieved from public sources such as publicly accessible sandboxes or other sources, or from private sources. In examples, this data is in the form of packets of data captured from internet or enterprise traffic and may be PCAP data. These packets are of known traffic types, such as specific types of malware or ransomware, internet scanning, or benign.

At step 254, the method 230 converts the PCAP data to flow metadata and then runs the same inference RFC process (step 238, for example) to determine appropriate labels for the ground truth flow data. The RFC process generates numeric labels. In example embodiments, the numeric label can then be substituted with a more meaningful value that is more useful to human analysts.

At step 258, the method 230 includes contextualizing flow data for a human analyst. Contextualizing may include any information to assist the human analyst identify a security threat in flow data being analyzed by the human analyst. For example, the clustering and labels added by step 256 may associate known malicious network activity with a particular label or cluster identifier. Step 258 may include a process of comparing labels for flow data from step 256 with labels from step 250. If a match is found, or similar labels are found by step 258, the step may further include advising that human analyst of the similarity. For example, step 258 may include notifying the human analyst that, based on known malicious data, a particular type of malware has generated flows having aspects similar to the flows the human analyst is currently viewing. The contextualization of step 258 may be more direct, such as “based on similarities among current product flows and known malicious flow data, the current flow should be investigated further. The following users should be notified about a heightened risk.” Any suitable information may be provided to the human analyst.

At step 260, the human analyst or another actor may take action to limit the risk of the threat. Any suitable action may be taken, such as advising the customer, quarantining network activity associated with the identified threat, suspending access to the customer network from IP addresses associated with the identified threat. In another example, if the context indicates that a particular malware attack may be occurring, the human analyst may review current network activity to determine if the suggested malware activity is actually occurring in the network.

In some examples, a threat may be identified by the method 230 to the human analyst accessing a user interface, dashboard or other control configuration that receives information about network operations. The method 230 may suggest to the human analyst an action or response to a threat identified by the step 258 and the proposal may be accepted or implemented by the human agent. In another example, at step 260, the human agent may respond to an identified threat by requesting of the system additional information about a type of malware identified at step 258, or by blocking access to a URL that may be identified at step 258 as being associated with a phishing email. Phishing may include a fraudulent practice of sending emails or other messages purporting to be from a reputable source in order to induce an individual recipient to take some action such as revealing personal information. In another example, the human analyst may take action to block an IP address or port on a firewall that protects the customer network.

The disclosed system and method provide many distinct advantages. The solution is extensible, such that it is not tailored toward identifying evidence of any one particular threat actor or malware family. And while it can identify virtually any type of malicious network traffic, it also provides the cyber-threat analyst with more specific information than existing solutions—it can identify the specific type of malware (ex. Cobalt Strike) along with identifying flows in the network under analysis, such as a particular company's enterprise network, that exhibit malicious behavior. An example is communication with a botnet Command and Control server.

The flexibility of the system stems from the fact that it identifies malware using flow data rather than being a signature-based system. In a signature-based system, even high-quality threat signatures can be subverted by the threat actor changing particular parts of malware content. However, it is often the case that modified malware produces flows with similar characteristics, making the disclosed system and method more reliable for identifying malware over time across many malware updates.

The disclosed system and method are also scalable, which is important for analysis of flow data. In examples, such flow data can amass in the millions or even billions of flow records per hour.

Other benefits are provided by a feature of labeling flow data that identifies and predicts specific malicious network traffic and threat actors potentially targeting the customer network. This allows rapid defensive measures to prevent intrusion and compromise of customer assets. Further, this offers the potential of cost savings in cyber-threat analyst staff time in attack identification, recovery, and remediation. Including the disclosed system and method in a cyber security service will enable pro-active alerting and enterprise security, including prescription of potential defensive measures before an attack occurs, preventing damage to network availability, such as a DDOS attack), financial loss such as a ransomware attack, and negative perception of a company or an agency by the public, such as due to data leakage.

While for purposes of simplicity of explanation, the respective processes are shown and described as a series of blocks in FIG. 2B, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

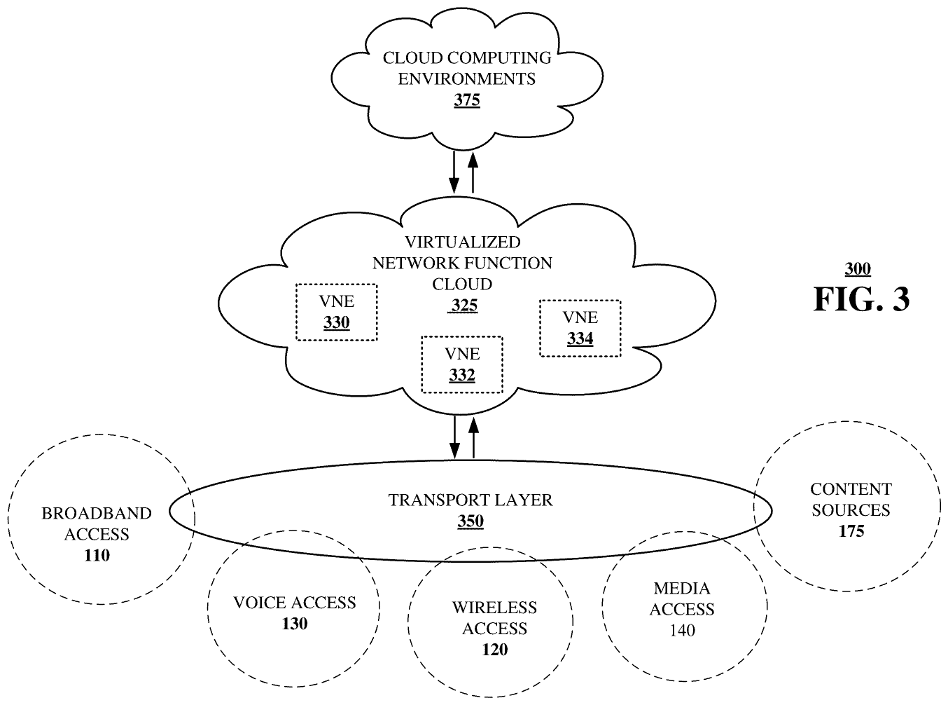

Referring now to FIG. 3, a block diagram is shown illustrating an example, non-limiting embodiment of a virtualized communication network in accordance with various aspects described herein. In particular a virtualized communication network 300 is presented that can be used to implement some or all of the subsystems and functions of system 100, the subsystems and functions of system 200, and method 230 presented in FIG. 1, FIG. 2A, FIG. 2B, and FIG. 3. For example, virtualized communication network 300 can facilitate in whole or in part classifying network flow data in the system 100 by assigning a label to similar flow records and comparing the labeled flow records with known malicious network flow traffic to identify a source of the malicious traffic in the current network traffic.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements-which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers—each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

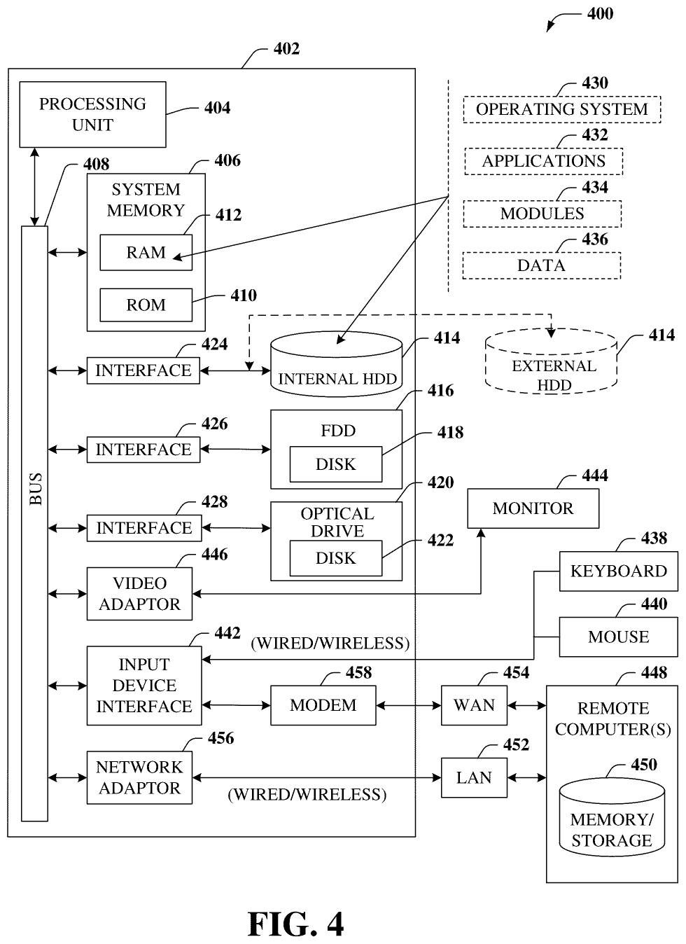

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part classifying network flow data in a network such as an enterprise network by assigning a label to similar flow records and comparing the labeled flow records with known malicious network flow traffic to identify a source of the malicious traffic in the current network traffic.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CDROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are examples and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

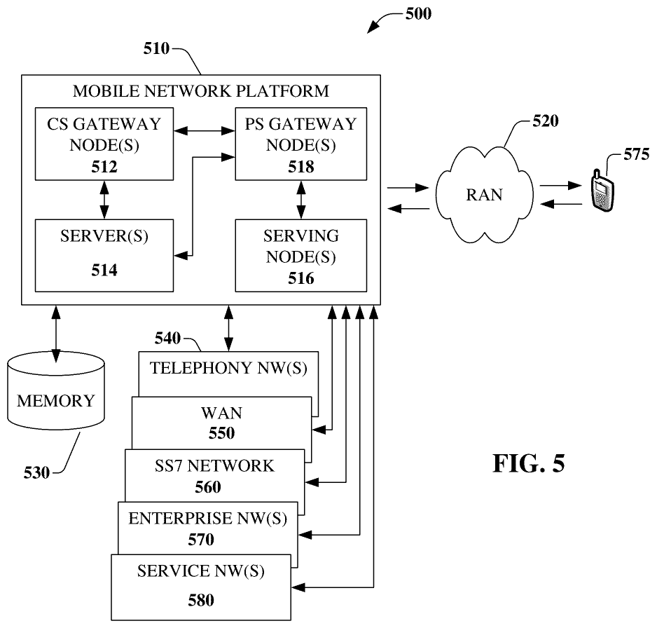

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part classifying network flow data in a network by assigning a label to similar flow records and comparing the labeled flow records with known malicious network flow traffic to identify a source of the malicious traffic in the current network traffic. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technologies utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

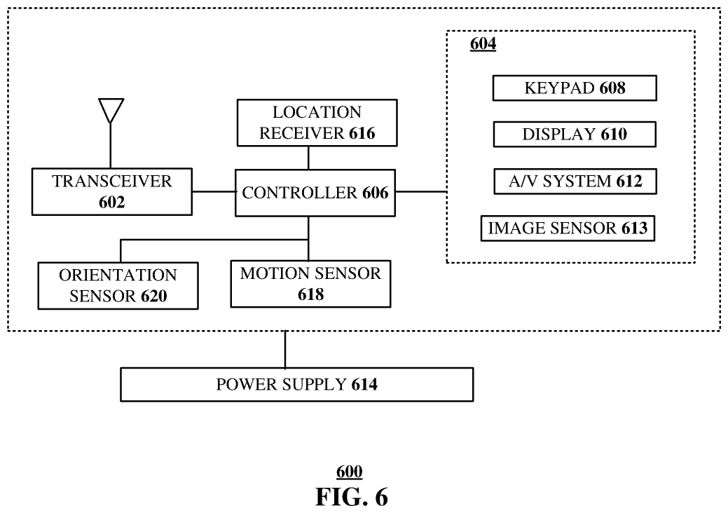

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, communication device 600 can facilitate in whole or in part classifying network flow data by assigning a label to similar flow records and comparing the labeled flow records with known malicious network flow traffic to identify a source of the malicious traffic in the current network traffic.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VOIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human car) and high-volume audio (such as speakerphone for hands free operation). The audio system 612 can further include a microphone for receiving audible signals from an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
receiving information about known malicious activity, the information about known malicious activity corresponding to a known cyber threat to operation of a network or data processing system;
using a clustering process to label flow data for identifying the information about known malicious activity, forming cluster labels receiving production flow data corresponding to current network traffic arriving at the network or the data processing system;
determining clusters and cluster identifiers for the production flow data;
identifying a relationship between a cluster label for the information about known malicious activity and a cluster identifier for the production flow data; and
based on the relationship between the cluster label for the information about known malicious activity and the cluster identifier, identifying a potential cyber threat to the network or the data processing system.

2. The device of claim 1, wherein the operations further comprise:
based on the relationship between the cluster label for the information about known malicious activity and the cluster identifier, providing contextualizing information regarding the production flow data based on the information about known malicious activity as an alert to a potential cyber threat.

3. The device of claim 1, wherein the operations further comprise:
determining a confidence parameter for the clusters and cluster identifiers for the production flow data;
collecting, from the production flow data, a plurality of outlier flows, each outlier flow having a confidence parameter that does not exceed a confidence threshold, forming an outlier pool; and
determining additional clusters based on the outlier pool.

4. The device of claim 3, wherein the operations further comprise:
identifying flows in the training flow data having new cluster identifiers, forming outliers;
identifying flows in the production flow data having infrequently seen cluster identifiers, forming additional outliers;
determining new cluster identifiers based on coincidence over time of similar outliers among the outliers and the additional outliers; and
combining the new cluster identifiers with previously identified cluster identifiers for evaluating future production data.

5. The device of claim 1, wherein the receiving information about known malicious activity comprises:
receiving information about network traffic generated by a malicious source accessed in a contained environment.

6. The device of claim 5, wherein the receiving information about known malicious activity comprises:
receiving, from an open source sandbox, information about an executable file executed in the contained environment of the open source sandbox; or
receiving, from the open source sandbox, information about a suspicious network location (URL) accessed in the contained environment of the open source sandbox.

7. The device of claim 5, wherein the operations further comprise:
receiving the information about network traffic generated by a malicious source in an IP packet; and
converting the information from the first format to flow data.

8. The device of claim 7, wherein the operations further comprise:
processing sandbox flow data in a classifier to infer labels for the flow data;
processing the production flow data in the classifier to infer labels for the production flow data; and
based on the labels for the flow data and the labels for the production flow data, populating a knowledge base to associate a type of cyber threat with a type of flow in the production flow data.

9. The device of claim 1, wherein the operations further comprise:
taking action to prevent actual damage to the network or the processing system from the potential cyber threat.

10. The device of claim 9, wherein the taking action to prevent actual damage comprises:
identifying internet protocol (IP) addresses associated with the potential cyber threat; and
suspending access to the network or data processing system from the IP addresses associated with the potential cyber threat.

11. A non-transitory machine-readable medium, comprising executable instructions that, when executed by a processing system including a processor, facilitate performance of operations, the operations comprising:
receiving production flow data corresponding to current network traffic arriving at a network;
providing the production flow data to a classifier;
receiving, from the classifier, inferred labels for flows of the production flow data; and
based on a relationship between the inferred labels for the flows of the production flow data and labels for flows from known malicious activity, identifying in the production flow data a potential cyber threat to the enterprise network.

12. The non-transitory machine-readable medium of claim 11, wherein the operations further comprise:
providing the training flow data to a clustering process to identify relationships between features of the production flow data and to produce clustered data having corresponding labels;
providing features identified by the clustering process and the corresponding labels to the classifier as training data for the classifier; and
receiving, from the classifier, the inferred labels for flows of the production and ground truth flow data, the inferred labels having been generated by the classifier based on the training data such that flows with the same inferred labels can be considered having the same or similar origin.

13. The non-transitory machine-readable medium of claim 11, wherein the operations further comprise:
receiving, from the classifier, information about a confidence in an inferred label for a flow of the production flow data;
assigning the flow of the production flow data as an outlier flow; and
forming a plurality of outlier flows into a new cluster.

14. The non-transitory machine-readable medium of claim 13, wherein the operations further comprise:
for each outlier flow, determining a probability of the outlier flow belonging to a previously known label of the corresponding labels; and
based on the probability, associating the outlier flow with outlier flows of the plurality of outlier flows to form the new cluster.

15. The non-transitory machine-readable medium of claim 11, wherein the operations further comprise:
identifying suggested malware activity associated with the potential cyber threat; and
retrieving current network activity to identify the suggested malware activity occurring in the network.

16. The non-transitory machine-readable medium of claim 11, wherein the operations further comprise:
receiving information about the known malicious activity, the information about the known malicious activity corresponding to a known cyber threat;
identifying cluster labels for the information about known malicious activity; and
based on a relationship between the cluster labels for the information about known malicious activity and the inferred labels for flows of the production flow data, generating contextualizing information regarding the production flow data based on the information about known malicious activity as an alert about the potential cyber threat.

17. The non-transitory machine-readable medium of claim 16, wherein the receiving information about the known malicious activity comprises:
receiving information about network traffic generated by a malicious source accessed in a sandbox environment;
processing the information about network traffic generated by a malicious source in the classifier to infer labels for the information about network traffic; and
based on the labels for the information about network traffic generated by a malicious source and the inferred labels for the flows of the production flow data, associating a type of cyber threat with a type of flow in the production flow data.

18. A method, comprising:
receiving, by a processing system including a processor, ground truth information about known malicious activity in data networks;
identifying, by the processing system, cluster labels for the ground truth information;
receiving, by the processing system, production flow data corresponding to current network traffic arriving at a network, the production flow data comprising flows of the production flow data;
determining, by the processing system, cluster identifiers for flows of the production flow data; and
based on relationships between the cluster labels for the ground truth information and the cluster identifiers for the flows of the production flow data, identifying, by the processing system, a potential cyber threat to the network.

19. The method of claim 18, comprising:
clustering, by the processing system, the production flow data based on common features among flows of the production flow data.

20. The method of claim 18, comprising:
receiving, by the processing system, information about a confidence in a cluster identifier for a flow of the production flow data;
assigning, by the processing system, the flow of the production flow data as an outlier flow; and
forming, by the processing system, a plurality of outlier flows into a new cluster based on a probability of the outlier flow belonging to a previously known cluster identifier.
